(19) United States
(12) Patent Application Publication
(10) Pub. No.: US 2012/0217309 A1
(43) Pub. Date: Aug. 30, 2012

(54) CARD INCORPORATING A TRANSPONDER

(75) Inventor: François DROZ, Corcelles (CH)

(73) Assignee: NagralD S.A., La Chaux-de-Fonds (CH)

(21) Appl. No.: 13/403,499

(22) Filed: Feb. 23, 2012

(30) Foreign Application Priority Data
Feb. 25, 2011 (EP) 11156040.5

(51) Int. Cl. G06K 19/067

(52) U.S. Cl. 235/492

(57) ABSTRACT

Card incorporating a transponder, including an electronic unit and an antenna electrically connected to the electronic unit, wherein the antenna is formed by an uninsulated conductor track, which is arranged on an insulating support. The track defines at least one winding and has first and second ends respectively located on either side of the at least one winding. The electronic unit is arranged inside or outside the at least one winding on a side of the first end, to which it is electrically connected. The second end of the track is electrically connected to the electronic unit by an electric wire fitted with an insulating sheath crossing the at least one winding, wherein the first and second end parts of the electric wire are at least partially stripped to assure there are electrical contacts necessary for an electrical connection between the second end of the track and the electronic unit.

This application claims priority from European Patent Application No. 11156040.5 filed 25 Feb. 2011, the entire disclosure of which is incorporated herein by reference.

### TECHNICAL FIELD

The present invention relates to the field of electronic cards comprising a transponder formed from an electronic unit and an antenna with at least one winding. Other electronic elements can also be incorporated into such cards. The term card is understood to mean not only plastic cards in bank format and other cards extending in a general main plane with any type of contour, but also tokens, tickets, labels etc. In particular, the present invention relates to access cards or RFID cards fitted with a transponder that allows them to be identified remotely by a radiofrequency reader (RF).

### TECHNOLOGICAL BACKGROUND

Transponders have been integrated into electronic cards with coil-type antennas for many years. In particular, the coil antenna is formed by an uninsulated conductor track (i.e. in which the face opposite the insulating support is not covered by an insulating film or lacquer before formation of electrical connections from the antenna to the electrical unit). The conductor track is arranged on an insulating support by defining some windings that are separated from one another. This conductor track can be deposited by a printing technique or be engraved into a conductive sheet firstly deposited onto the insulating support.

A problem that has long been known in the production of electronic cards of the type described above comes from the fact that the two ends of the coil antenna are located respectively on either side of the windings, which poses a problem in electrically connecting these two ends to the electronic unit. Various solutions have already been proposed. In particular, it has been proposed to arrange the electronic unit above the windings, but such a technique is only conceivable in particular cases with a relatively large electronic unit or a coil with few windings. The formation of the card is not so straightforward because it is not necessary that a laminating stage embeds the electronic unit in the support dividing the antenna into sections. Thus, within the framework of the present invention it is provided that the electronic unit is arranged inside or outside the windings of the antenna. In the latter case, to resolve the connection problem it is proposed to use vias through the insulating support with the deposit of a connection strip on the back of this support. This technique is relatively complex since it is necessary to form the vias and arrange the conductor tracks on the two opposite faces of the insulating support. To overcome this disadvantage, patent document EP 1 168 239 (see FIG. 2 therein) proposes to arrange an insulating bridge across the windings of the printed antenna. This insulating bridge can also be deposited using a printing technique. A section of conductor track is then printed onto the insulating bridge to connect two contact pads respectively located on either side of the windings of the antenna. This latter technique requires several successive operations that increase the production time and therefore the cost of the cards obtained.

### SUMMARY OF THE INVENTION

The aim of the present invention is to provide an electronic card incorporating a transponder that can be produced at less cost while still being reliable.

On this basis, the present invention relates to an electronic card incorporating a transponder, which comprises an electronic unit and an antenna electrically connected to this electronic unit, wherein this antenna is formed by an uninsulated conductor track, which is arranged on an insulating support, and the conducting wire or conductor track defines at least one winding and has a first end and a second end respectively located on either side of this at least one winding. The electronic unit is arranged inside or outside said at least one winding on the side of the first end of the conductor track and is electrically connected to this first end. The second end of the conductor track is electrically connected to the electronic unit by an electric wire fitted with an insulating sheath crossing said at least one winding, wherein the first and second end parts of this electric wire are at least partially bare to assure the electrical contacts necessary for the electrical connection between the second end of the conductor track and the electronic unit.

According to a preferred embodiment, the first and second end parts of the electric wire respectively have first and second flattened and stripped zones defining two electrical contact zones of this electric wire.

### BRIEF DESCRIPTION OF THE DRAWINGS

The present invention will be described in more detail in the following description of an embodiment, variants thereof and an installation for the supply of the insulated electric wire and its arrangement on the insulating support, wherein this description is made with reference to the attached drawings that are given as completely non-restrictive examples:

FIG. 1 is a partial plan view of an electronic card according to the invention during production;

FIG. 2 is a view in partial section of the electronic card during production shown in FIG. 1;

FIG. 3 is a view in partial section similar to that of FIG. 2 of the electronic card of FIG. 1 in finished state and of the intermediate body of such an electronic card;

FIG. 4 is a partial plan view of a variant of an electronic card according to the invention during production; and

FIG. 5 schematically shows an installation for feeding sections of insulated electric wire with their two bare ends taking part in the production of electronic cards according to the invention.

### DETAILED DESCRIPTION OF THE INVENTION

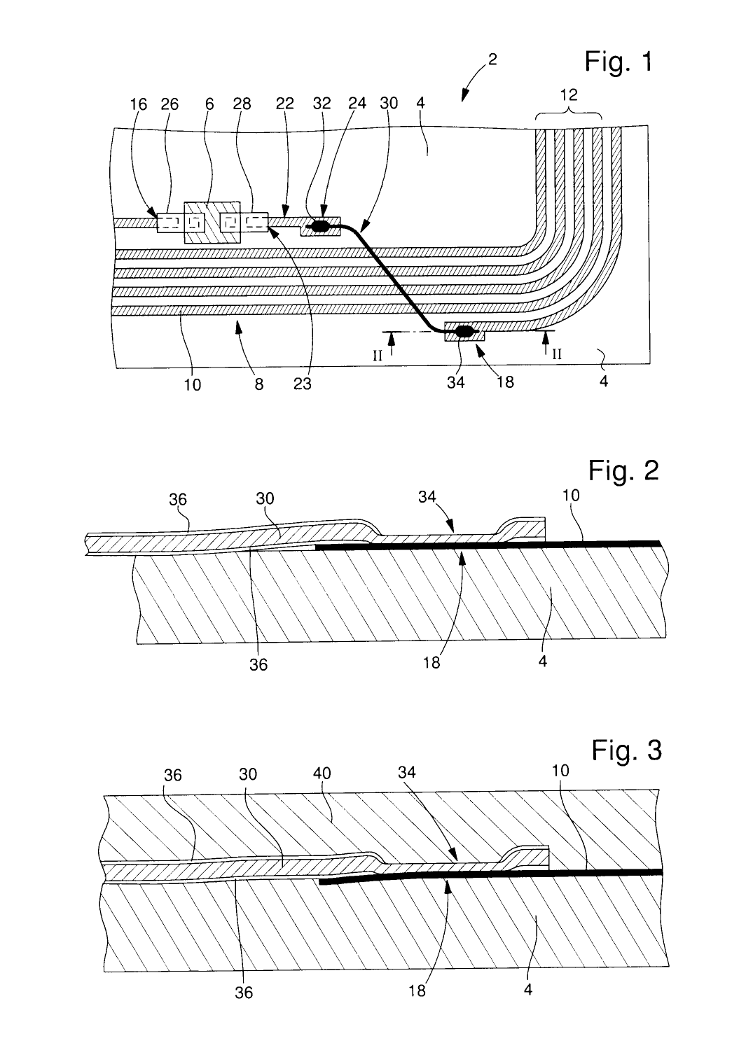

An embodiment of an electronic card according to the invention will be described below on the basis of FIGS. 1 and 2, said card being partially shown in these figures. The electronic card 2 comprises a transponder incorporated into its body, i.e. in the interior of the card. This transponder is formed by an electronic unit 6 electrically connected to an antenna 8. This antenna is formed by an uninsulated conductor track 10, which is arranged on an insulating support 4 and defines several windings 12 (the invention also relates to a variant with a single winding). The conductor track is obtained, for example, by printing with a conductive ink or by engraving into a metallic film deposited onto the support 4. The antenna has a first end 16 and a second end 18 respectively located on either side of the windings 12. The electronic unit 6 is arranged inside these windings on the side of said first end 16, at which it is electrically connected by a metal tab 26. In another variant, the electronic unit is located outside the windings.

In general, said second end of the conductor track 10 is electrically connected to an electronic unit 6 by an electric wire 30 fitted with an insulating sheath 36. This electric wire crosses the windings 12 and its first and second end parts are at least partially bare to assure the necessary electrical contacts for the electrical connection between the second end 18 of the conductor track and the electronic unit 6. The bare zones are located on either side of the windings 12, the part of the electric wire 30 being superposed on these windings is insulated by the insulating sheath that surrounds it. Thus, the passage across the windings does not cause any problem of short-circuiting. Since the supplied wire is itself insulated, it is not necessary to cover these windings at least locally with a protective insulating film as in the prior art.

In the variant shown in FIG. 1, an additional section of conductor track 22 that defines the first and second contact pads 23 and 24 is arranged on the insulating support 4 on the side of the electronic unit relative to the windings 12. The first contact pad 23 is electrically connected to the electronic unit by a metal tab 28. The first and second end parts of the electric wire 30 respectively have first and second flattened and stripped zones 32 and 34 that define two electrical contact zones of this electric wire. The first flattened and stripped zone 32 is superposed on the second contact pad 24 of the additional section of conductor track 22 and is electrically connected to this second pad. The second flattened and stripped zone 34 is superposed on the second end 18 of said conductor track 10 forming the antenna and is electrically connected to this second end.

It will be noted that in another embodiment that is not shown in the figures the second end of the electric wire 30 is directly connected to a contact pad of the electronic unit formed in particular by a contact block. It will also be noted that the two bare ends of the electric wire 30 may be not flattened. The lamination allows the two contact pads to be deformed, which then mould to the circular wire over a certain contact surface. In an embodiment the ends of the electric wire are soldered to the corresponding contact pads. In this last case, the soldering operation can jointly serve to strip the electric wire.

In an advantageous variant, the electrical contact between the first flattened and stripped zone 32 of the electric wire and the second contact pad 24 of the section of conductor track 22 as well as the electrical contact between the second flattened and stripped zone 34 of the electric wire and the second end 18 of the conductor track 10 are made without soldering. As shown in FIG. 3, an encasing material assures that these flattened and stripped zones are pressed respectively against the second contact pad 24 and against the second end 18 of the conductor track. In this variant the encasing is achieved by the support 4 and an upper layer 40 that are laminated together. The physical contact that assures the electrical connection is maintained by the upper layer that adheres firmly to the support 4. It will be noted that subsequent to the laminating step, the interface between the support 4 and the upper layer 40 can disappear so that they only form a single plastic mass encasing the transponder and forming a body of the card. Card 42 can define a finished card, on which a printed pattern can possibly be provided in a final step or can define a “prelam” or “inlet”, i.e. an intermediate product to be finished by providing additional layers or films to its faces.

In FIG. 1 the end 18 of the conductor track 10 has a width larger than that of the section of the conductor track that forms the windings 12. However, in another variant the end 18 and the windings have the same width.

The electric wire 30 with its insulating sheath 36 can have a relatively small diameter, preferably a diameter in the range of between 50 and 150 microns (50-150 μm). A person skilled in the art would not have envisaged this solution with an electric wire, in particular with an essentially circular cross-section, in such a card obtained by a process including a laminating operation. In fact initially such a solution appears to be technically inappropriate since it is expected that the electric wire 30 will divide the windings 12 into sections in the laminating step. However, with an electric wire of small diameter in particular, it has been found that the windings are not divided into sections without modifying the lamination and this occurs even with a printed conductor track. A conductor track obtained by engraving a metal film deposited onto the support 4 is even sturdier and supports electric wire diameters that are greater than 150 μm without any problem. Moreover, with a large diameter a person skilled in the art can adjust the different parameters of the lamination to allow a deformation of the windings under the electric wire without these being ruptured.

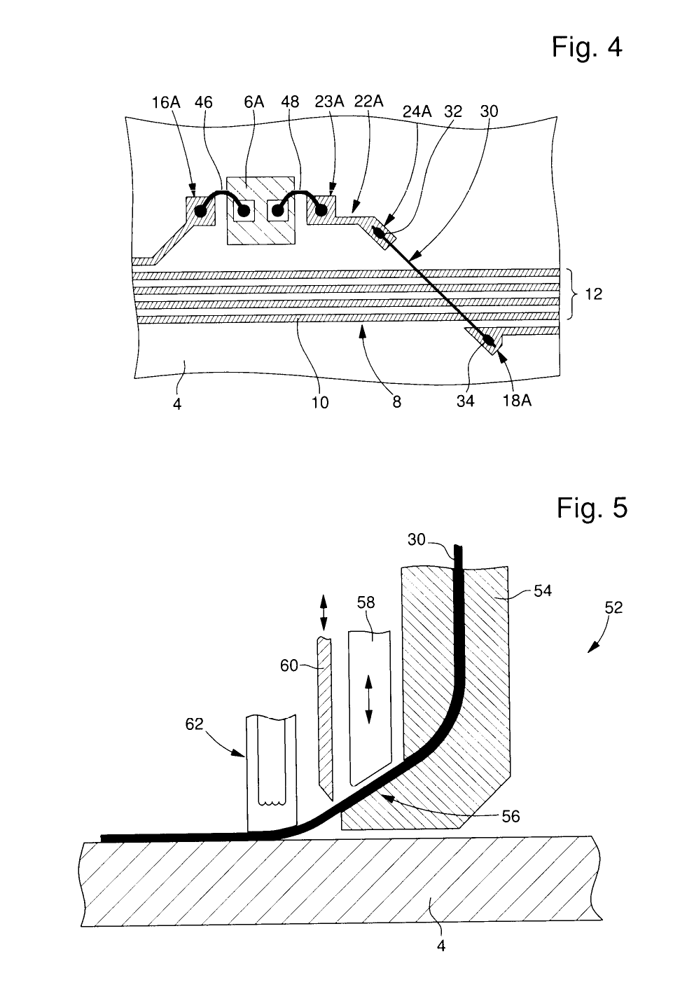

FIG. 4 shows a variant of the card of FIG. 1. In the variant of FIG. 1 the end parts of the electric wire 30 are aligned in the direction of the windings 12 in the region in which this electric wire and these windings cross, while the central insulated part of this electric wire crosses the windings of the antenna 8 obliquely. Thus, the electric wire has a non-rectilinear course, which can be achieved without great difficulty, but using a relatively sophisticated installation developed within the framework of the present invention that will be described below on the basis of FIG. 5. In the variant of FIG. 4 the end 18A of the conductor track 10 and the contact pad 24A of the conductor section 22A are configured so that the end parts, in particular the contact zones 32 and 34, of the electric wire 30 are aligned on the central part of this electric wire so that it retains the same rectilinear direction over its entire length. Without any direct connection with the invention, the electronic unit 6A comprises two contact pads connected to the pads 16A (first end of the conductor track) and 23A (first contact pad of the additional conductor sector) by soldering wires 46 and 48 (wire bonding technology).

FIG. 5 schematically shows an installation 52 for feeding the electric wire 30 onto the support 4 of the card during production. This installation is adapted to a production of multiple cards lot by lot. The electric wire 30 necessary for each card is in fact a section of wire that has been given the same reference 30. This installation enables such sections of electric wire that are insulated in two flattened and stripped zones (therefore without insulating sheath 36) respectively in the two end parts of each section of wire to be produced successively at a high production rate. Moreover, this installation allows a section to be deposited along a non-rectilinear course as shown in FIG. 1, for example. On this basis, the installation 52 comprises a head with a channel, in which the electric wire 30 is fed to a terminal part 56 of this head having an inclined surface that defines an impact surface for a striking or piercing tool 58 that is movable in vertical direction and is provided to form the two contact pads of each section of wire produced. This striking tool is followed by a blade 60 that is also vertically movable and is provided to divide the pieces of electric wire 30 into sections. In a variant scissors are provided in place of the movable blade to facilitate and assure the division of the wire into sections. Finally, a pressing member 62 follows the blade and serves to press the electric wire against the support 4. To facilitate this operation, the pressing member 62 is preferably fitted with a heating element to heat the sheath 36 slightly. It will be noted that it is possible to reverse the striking tool and the blade since the pressing member 62 holds the wire in place. In a preferred variant, the sheath 36 is thermally adhesive so that the application of heat enables the wire to adhere to the support 4 and to the windings 12. In another variant, it is provided to cause the electric wire to penetrate the support 4 a short distance by means of the pressing member with or without an application of heat, as shown in FIG. 2.

The installation functions as follows: the insulated electric wire 30 is pushed into the channel of the head 54 and the striking tool squeezes the electric wire 30 a first time to form a first flattened zone that is at least partially stripped. The localised removal of the insulating sheath is achieved by the striking tool during squeezing, which locally varies the shape of the electric wire causing the sheath to burst locally as a result of deformation of the tubular shape of this sheath and because the periphery with a circular cross-section is smaller than the periphery with a rectangular cross-section of the same surface if the squeezing action is significant. As an example, the circular electric wire has a diameter of about 80 μm and the flattened zone has a thickness of about 30 μm. Simultaneously or at least before this flattened zone goes past the position of the blade 60, this blade is moved down (or the scissors are actuated) to divide the wire into sections and to form a first terminal part of the section of electric wire to be deposited onto the support 4. The wire is then pushed into the head and the first terminal part comes under the pressing member 62, which presses it against the support so that the first flattened and stripped zone is superposed on a first contact pad arranged on this support. The installation 52 is then displaced horizontally in synchronization with the forward movement of the wire in the channel of the head 54 along a predetermined course to cross the windings of the antenna into the vicinity of a second contact pad of the support. The striking tool is then actuated again to form the second flattened and at least partially stripped zone, which is then moved beyond the blade 60, which then cuts the wire once again to define its second terminal part. The head continues to be moved and this second terminal part moves below the pressing member, which presses it against the support so that the second flattened and stripped zone is superposed on the second contact pad of the support 4.

Finally, it will be noted that in other exemplary embodiments of the process for forming the transponder on an insulating support according to the invention, the operation of stripping the insulation from the terminal parts of the electric wire 30 can be performed by a thermode applied locally to these terminal parts or by a welding torch generating a small flame to allow the insulating sheath to be locally sublimated.

What is claimed is:

1. A card incorporating a transponder, which comprises an electronic unit and an antenna electrically connected to this electronic unit, wherein this antenna is formed by an uninsulated conductor track, which is arranged on an insulating support, and this conductor track defines at least one winding and has a first end and a second end respectively located on either side of this at least one winding, wherein said electronic unit is arranged inside or outside this at least one winding on the side of the first end, to which it is electrically connected, wherein said second end of the conductor track is electrically connected to the electronic unit by an electric wire fitted with an insulating sheath crossing said at least one winding, wherein the first and second end parts of this electric wire are at least partially stripped to assure the electrical contacts necessary for the electrical connection between said second end of said conductor track and the electronic unit.

2. The card according to claim 1, wherein said first and second end parts of said electric wire respectively have first and second flattened and stripped zones defining two electrical contact zones of said electric wire.

3. The card according to claim 2, wherein an additional section of conductor track, defining first and second contact pads, is arranged on said insulating support on the side of said electronic unit relative to said at least one winding, wherein the first contact pad is electrically connected to said electronic unit and said first flattened and stripped zone is superposed on said second contact pad and electrically connected to this second pad, and wherein said second flattened and stripped zone is superposed on said second end of said conductor track and electrically connected to this second end.

4. The card according to claim 3, wherein the electrical contact between the first end part of the electric wire and said second contact pad as well as the electrical contact between the second end part of the electric wire and said second end of said conductor track are made without soldering, wherein an encasing material assures that these flattened and stripped zones are pressed respectively against said second contact pad and against said second end of said conductor track.

5. The card according to any one of the preceding claims, wherein said electric wire has a diameter in the range of between 50 and 150 microns.
